(19) United States
(12) Patent Application Publication
(10) Pub. No.: US 2012/0143985 A1
(43) Pub. Date: Jun. 7, 2012

(54) METHOD AND SYSTEM FOR MESSAGE CONCATENATION

(75) Inventors: Scott Douglas Constien, Plano, TX (US); Hal Keithley, Lewisville, TX (US); Steve Belknap, Plano, TX (US); Debra Thompson, Richardson, TX (US)

(73) Assignee: Enfora, Inc., Richardson, TX (US)

(21) Appl. No.: 13/308,219

(22) Filed: Nov. 30, 2011

Related U.S. Application Data
(60) Provisional application No. 61/418,325, filed on Nov. 30, 2010.

(51) Int. Cl. G06F 15/16

(52) U.S. Cl. 709/217

(57) ABSTRACT

In one embodiment, a method includes receiving data associated with an event. The method includes identifying a parameter of the event. The method also includes identifying a buffer to store the data associated with the event based on the parameter the event. The method further includes storing the data associated with the event in the buffer. The method also includes determining whether data stored in the buffer meet a predetermined condition. The method further includes sending the data in the buffer.

### CROSS-REFERENCE TO RELATED APPLICATION(S) AND CLAIM OF PRIORITY

The present application is related to U.S. Provisional Patent Application No. 61/418,325, filed Nov. 30, 2010, entitled “METHOD AND SYSTEM FOR MESSAGE CONCATENATION”. Provisional Patent Application No. 61/418,325 is hereby incorporated by reference into the present application as if fully set forth herein. The present application hereby claims priority under 35 U.S.C. §119(e) to U.S. Provisional Patent Application No. 61/418,325.

### TECHNICAL FIELD

Generally, this disclosure relates to data transfers, and, more specifically, to the optimization of data within a wireless network using the aggregation of separate messages into a single message based upon certain predefined rules or models.

### BACKGROUND

Wireless data networks provide standard Internet Protocol (IP) delivery of data from a carrier network to a client. Traditional data systems transmit data upon receipt. This configuration may be inefficient, as several small data transmissions may be significantly more expensive than one large data transmission. Moreover, the power requirements to send several small data transmissions may be higher than the power requirement to send one large data transmission. System and methods that can optimize data transfers are needed.

### SUMMARY

In one embodiment, a method includes receiving data associated with an event. The method includes identifying a parameter of the event. The method also includes identifying a buffer to store the data associated with the event based on the parameter the event. The method further includes storing the data associated with the event in the buffer. The method also includes determining whether data stored in the buffer meet a predetermined condition. The method further includes sending the data in the buffer.

In another embodiment, an apparatus includes a receiver, a controller, a buffer, and a transmitter. The receiver is configured to receive data associated with an event. The controller is configured to identify a parameter of the event and identify a buffer to store the data associated with the event based on the parameter the event. The buffer is configured to store the data associated with the event in the buffer. The controller is further configured to determine whether data stored in the buffer meet a predetermined condition. The transmitter is configured to send the data in the buffer.

In another embodiment, a non-transitory computer readable medium embodies instructions that, when executed, cause one or more processing systems to receive data associated with an event, identify a parameter of the event, identify a buffer to store the data associated with the event based on the parameter the event, store the data associated with the event in the buffer, determine whether data stored in the buffer meet a predetermined condition, and send the data in the buffer.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a system for concatenating data according to one embodiment of the present disclosure;

FIG. 2 illustrates a system for concatenating data using a plurality of buffers according to one embodiment of the present disclosure;

FIG. 3 illustrates a system for concatenating data using a plurality of transports according to one embodiment of the present disclosure;

FIG. 4 illustrates a system for concatenating data using a plurality of buffer conditions according to one embodiment of the present disclosure;

FIG. 5 illustrates a system for concatenating data using a plurality of send queues according to one embodiment of the present disclosure;

FIG. 6 illustrates a system for concatenating data using a reporting memory according to one embodiment of the present disclosure;

FIG. 7 illustrates a system for concatenating data using a reporting memory and a report condition according to one embodiment of the present disclosure;

FIG. 8 illustrates a system for concatenating data using a reporting memory and a single sending queue according to one embodiment of the present disclosure;

FIG. 9 illustrates a system for concatenating data using a plurality of sensors according to one embodiment of the present disclosure;

FIG. 10 illustrates a system for concatenating data using a rules set and a controller according to one embodiment of the present disclosure;

FIG. 11 illustrates a system for concatenating data using a rule set and a controller according to one embodiment of the present disclosure;

FIG. 12 illustrates an example processing system which may be used to concatenate messages according to one embodiment of the present disclosure; and

FIG. 13 illustrates a flowchart of a method of sending data according to one embodiment of the present disclosure.

### DETAILED DESCRIPTION

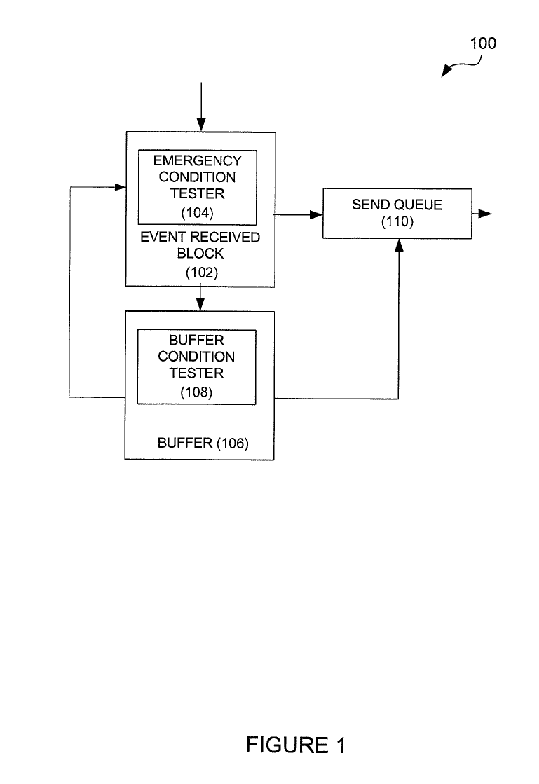

FIGS. 1 through 13, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In particular scenarios, data routing from mobile devices can be highly sensitive to costs during transit. For example, a carrier may have a set rate for 1 kB of data in which transmitting any amount of data from 0 to 1 kB results in the same fee. However, in many mobile devices, small data elements that are significantly less than 1 kb may be queued for transmission. Accordingly, in such scenarios, if these small transmissions could be aggregated into one transmission, there may be a significant cost savings.

In addition, in other scenarios, data transmissions may require significant power from a device. In particular, one or more components on the device (e.g., a transceiver) may need to be powered up prior to transmitting data. Thus, each time the transceiver is powered up, additional power is required. Accordingly, systems and methods that could aggregate various data transmissions into a single data set transmitted using a single power may provide an overall decrease in power consumption.

Prior art attempts to address problems discussed herein have failed to address problems associated with costs and power. Specifically, prior art implementations of transceivers fail to address factors such as costs related to fixed fee data transmissions and power within the device. One of the innovative elements of the present disclosure is the ability to delineate between emergency and nonemergency events, where an emergency event generates data which requires immediate transmission, and a non-emergency event which generates data that does not require immediate transmission. In this case, data derived from emergency events may be transmitted immediately, and non-emergency data may be transmitted in a more efficient manner.

FIG. 1 illustrates a system 100 for concatenating data according to one embodiment of the present disclosure. In this illustrative embodiment, the system 100 comprises an event received block 102, an emergency condition tester 104, a buffer 106, a buffer condition tester 108, and a send queue 110. As described below, the system 100 in particular embodiments may be associated with a wireless device or a device capable of communicating a wireless signal to other devices, for example, an embedded system with wireless communication capabilities. Examples of such devices may include both passive and active devices as well as wireless devices that are moveable or stationary. As non-limiting examples, the wireless devices may include mobile phones, wireless asset tracking devices, wireless automotive devices, wireless security devices, and wireless industrial sensors

When an data enters the system 100 using the event received block 102, the data can be registered into the system 100. The data is examined by the emergency condition tester 104 which determines if the data is an emergency event. If so, the system 100 passes the event into the send queue 110 for immediate transmission. If the event is not an emergency event, the emergency condition tester 104 passes the event into the buffer 106 for subsequent transmission. If the buffer condition tester 108 determines that the buffer condition is reached, the buffer 106 may be transferred into the send queue 110. If the buffer condition is not reached, the system delays transfer until additional data is sent.

In particular embodiments, one or more of the blocks pictured in FIG. 1 may be integrated as a single component whereas in other embodiments, one or more blocks pictured in FIG. 1 may operate as separate components. For example, in one embodiment one or more of the block pictured in FIG. 1 may operate in single integrated circuit (IC).

The event received block 102 accepts data containing an event message. This event message may relate to any element of data that may be collected by the system 100 or the wireless devices associated with the system 100. Examples of event messages may include, but are not limited to, the following type of data: ambient temperature, temperature of one or more modules or components within a device associated with the system 100, location of the device associated with the system 100, operational status of one or more modules or components within a device associated with the system 100, error messages, data which may be received by a sensor, memory, or other passive or active device coupled to the system 100, and any other data that may need to be communicated from the system 100 to another location. When the event is received, the event received block 102 may make a determination as to whether the event is an emergency event or a standard event.

An emergency event is an event that is to be treated in a different manner than standard events that are passed on to the buffer. A variety of different parameters may be used to classify an event as an emergency event, including, but not limited a priority of the event or the source of the event (e.g., the event coming from a particular device such as an alarm). Data derived from emergency events may be recognizable by the event received block 102 in a number of ways, including but not limited to the source of the data, or a designated header or flag.

In particular embodiments, the parameters used to classify an event as an emergency event may be modified, including in particular embodiments a dynamic modification of the criteria during operation of the system. As one non-limiting example, in certain embodiments, the system 100 may detect that the transmission cost and/or power consumption to transmit messages is low, allowing a threshold for emergency events to be lowered. Thus, events that may not be considered to be an emergency event in certain scenarios, but may become emergency events upon a lowering of the threshold criteria for emergency events.

Any method may be used by the event received block 102 to determine that data corresponds to an emergency event, including, but not limited to comparing the event to a emergency event list or database (which may be modified in certain embodiments), comparing the event priority level to a threshold level (which may be modified in certain embodiments), or reading a tag or header that may indicate that certain types of events are always emergency events.

The emergency condition tester 104 directs the message based upon whether the event is an emergency event. If there is a determination by the emergency condition tester 104 that the message corresponds to an emergency event, the message is transmitted into the send queue 110 for immediate transmission using, for example, a transceiver of the wireless device associated with the system. If the emergency condition tester 104 determines that the event is not an emergency condition, the event is routed into the buffer 106 for subsequent transmission.

Buffer 106 can store a data from at least one event. The buffer 106 may store data representing a single type of event or a plurality of different types of events. The buffer 106 may store the data in at least one computer readable medium until the buffer is instructed to transmit the data held in the buffer 106 to the send queue. This computer readable medium can be a temporary memory such as random access memory (RAM). The size of the buffer 106 may vary. In particular embodiments, data stored in the buffer can be stored from lengths of milliseconds to hours or days or even longer.

One of the innovative features of the buffer 106 is that the buffer 106 can function in a plurality of modes. In a first mode, the buffer 106 may insert a field delimiter in between messages to separate messages corresponding to a first and a second event. In a second mode, the buffer 106 may concatenate messages with a predetermined length. In certain embodiments, the buffer 106 may simultaneously act in both modes of operation for providing data for a single transmission. In the second mode of operation, the message may avail from efficiencies that accompany sending messages of similar types, including using the same header for multiple payloads, using flags to indicate no changes in value, and the like. In certain embodiments, the messages may be reordered (for example, according to type) to avail from efficiencies that may be gained from sending messages of the same type.

In particular embodiments, the buffer 106 may add identification information when transmitting the contents of the buffer to the send queue indicating what mode of operation the buffer 106 is using. In certain embodiments, a receiver of the data from the send queue 110 may need to be configured to accept data which is formatted by the buffer 106 as well as data that is not formatted by the buffer 106.

The send queue 110 is configured to transmit event messages. These event messages may relate to a plurality of different events and may further comprise additional information which is related the mode of operation of the buffer 106. In some embodiments, the send queue 110 may be configured to add a field delineator to an emergency event such that the format that event messages are transmitted from send queue 110 are consistent regardless of whether the event messages are emergency events or non-emergency events. In particular embodiments, the send queue 110 may be a send queue in a wireless device.

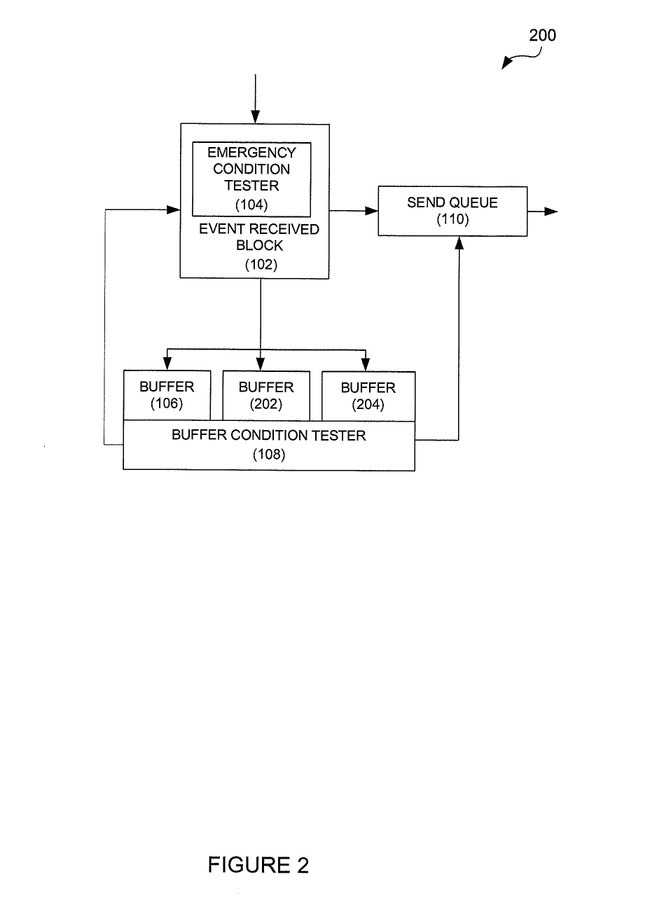

FIG. 2 illustrates a system for concatenating data using a plurality of buffers according to one embodiment of the present disclosure. The system 200 is an example of one implementation of the system 100 in FIG. 1. In this illustrative embodiment, in addition to buffer 106, system 200 includes buffers 202 and 204. The buffers 202, 204 are used in parallel with the buffer 106 to allow separate buffering of different types of data. For example, temperature data may be buffered in the buffer 106, location data may be buffered in the buffer 202, and battery status may be buffered in the buffer 204. By segregating the type of data into a plurality of buffers, data can be group together such that all of a particular type or priority of data is transmitted together.

The buffers may be further used to optimize data transmission by adding destination information to the data stored within the buffer. Therefore, buffers 106, 202, and 204 may be further used to not only store events to but also to append routing data to the events. In embodiments such as this, efficiencies can be gained as described above due to, among other things, a reuse of headers for payloads of data.

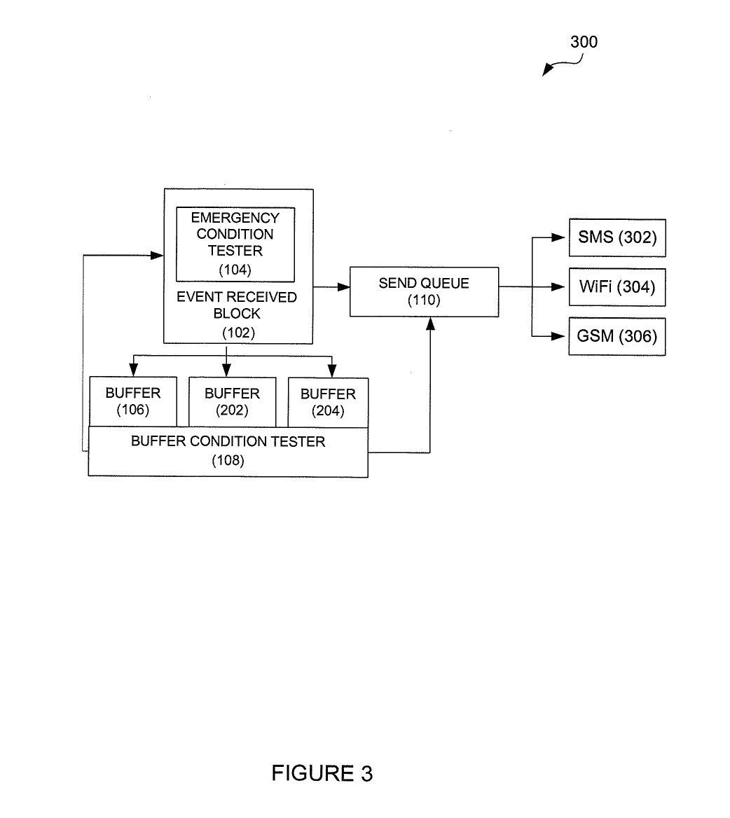

FIG. 3 illustrates a system 300 for concatenating data using a plurality of transports according to one embodiment of the present disclosure. The system 300 is an example of one implementation of the system 200 in FIG. 2. In this illustrative embodiment, system 300 utilizes a transports including short message service (SMS) 302, WiFi transport 304, and Global System for Mobile Communications (GSM) transport 306 coupled to the send queue 110. It is expressly contemplated that the send queue 110 may be used with any transmission scheme, transport network, or protocol. The examples shown in FIG. 3 are for illustrative purposes only and are not intended to be limited.

For instance, an emergency event may be sent through SMS messaging while a location event which, in some embodiments, is a nonemergency event may be sent using SMS only. It is further contemplated that the send queue 110 may transmit the event message using a plurality of different protocols and messaging schemes. The event messages may be sent using one or more of a plurality of wireless technologies including, but not limited to, satellite, GSM, CDMA, Wi-Fi, Wimax, and Bluetooth, and may be sent using one or more of a plurality of transport protocols, including but not limited to UDP and TCP.

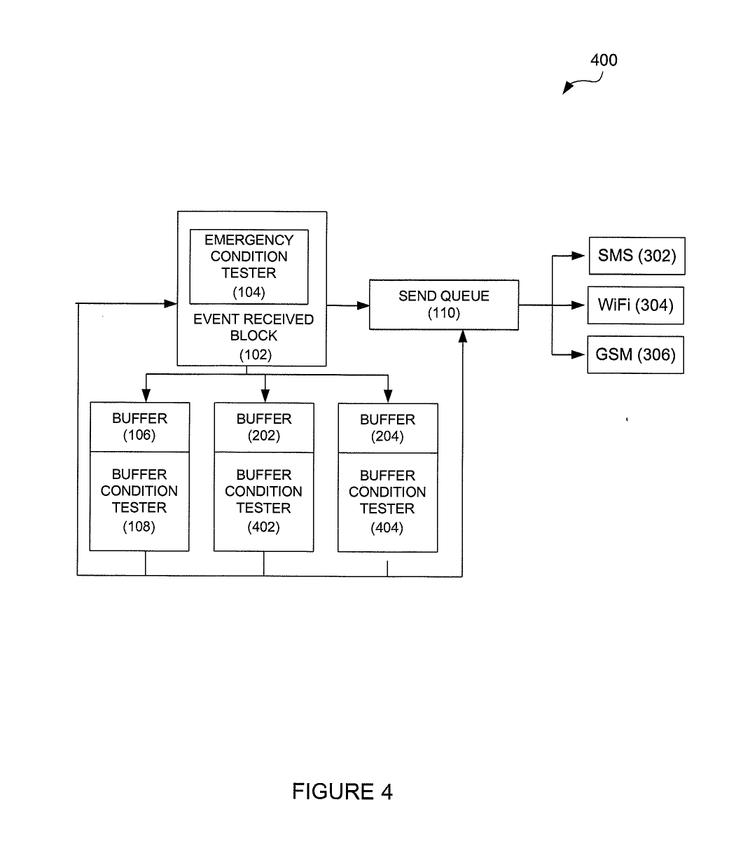

FIG. 4 illustrates a system 400 for concatenating data using a plurality of buffer conditions according to one embodiment of the present disclosure. The system 400 is an example of one implementation of system 300 in FIG. 3. In this illustrative embodiment, system 400 includes buffer condition testers 402 and 404.

In the example shown by FIG. 4, the buffer 106 is coupled to the buffer condition tester 108, the buffer 202 is coupled to the buffer condition tester 402, and the buffer condition tester 404 is coupled to the buffer 204. In some embodiments, each buffer condition tester may be designed to perform a different test based upon a different set of conditions. For instance, buffer condition tester 404 may have two sets of conditions, a first “time condition” and a second “full condition”. The time condition may require that data be flushed from the buffer 204 at a minimum time frequency. The full condition may require that data be flushed from the buffer 204 upon the buffer becoming full.

Additionally, in certain embodiments, the presence or absence of certain network technologies (satellite, GSM, CDMA, Wi-Fi, Wimax, and Bluetooth) may serve as a buffer condition to unload data. It is expressly contemplated that any number of buffer conditions may be present which allow for any number of variations on when the buffer condition testers 108, 402, and 404 will flush the buffers 106, 202, and 204.

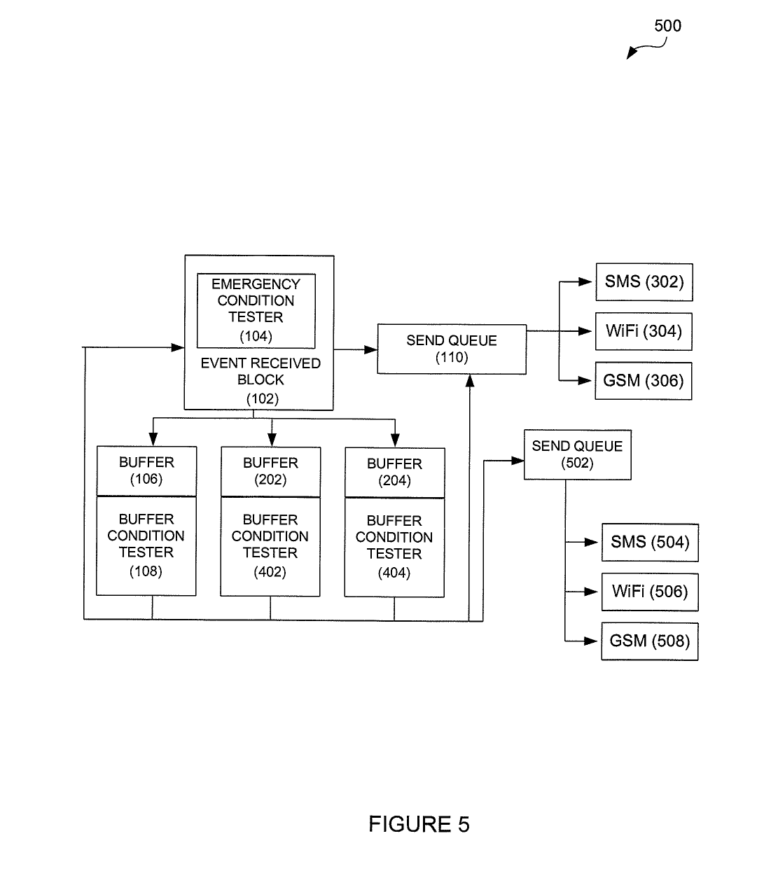

FIG. 5 illustrates a system 500 for concatenating data using a plurality of send queues according to one embodiment of the present disclosure. The system 500 is an example of one embodiment of the system 400 in FIG. 4. In this illustrative embodiment, the system 500 includes a second send queue 502 coupled to a second SMS transport 504, a second WiFi transport 506, and a GSM transport 508. The system 500 uses the second queue 502 send data from the buffers 106, 202, and 204. The use of a first and second queue 110, 502 allows the system 500 to transmit emergency events using a send queue 110 and non-emergency events using a second send queue 502. The use of two separate queues, with potentially different buffering capabilities, allows the system 500 to transmit data without using a single send queue for both emergency event and non-emergency events.

As an illustrative example of these different send queues, the send queue 110 in some embodiments may transmit emergency messages immediately, using satellite or GSM, whereas the send queue 502 may transmit less critical data when connected to a Wi-Fi network. In this case, buffers 106, 202 and 204, may be configured so that, in the presence of a Wi-Fi network, the system 500 forwards events to queue 502, taking advantage of the lower cost of transport. It is understood that the buffer behavior may be modified based upon transport availability.

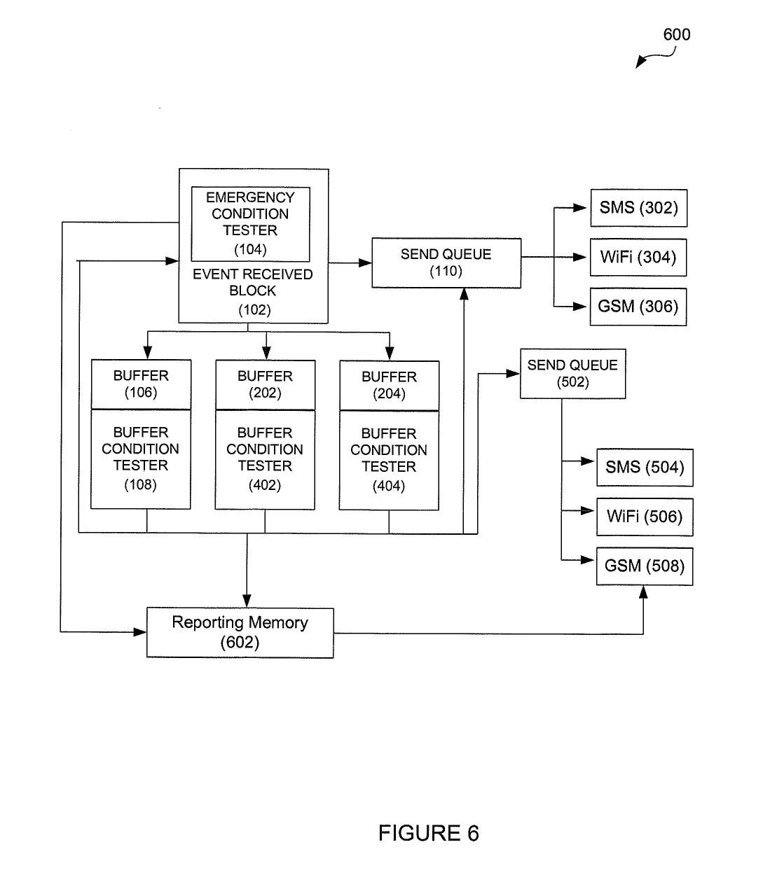

FIG. 6 illustrates a system 600 for concatenating data using a reporting memory 602 according to one embodiment of the present disclosure. The system 600 is an example of one implementation of system 500 in FIG. 5. In ₜhis illustrative embodiment, system 600 includes the reporting memory 602. The system 600 may copy certain data from the buffers 106, 202, and 204 into the reporting memory 602 for separate transmission. This allows for a single, cohesive, report to be formed, containing combinations of data from a collection of buffers. For example, system 600 may use reporting memory 602 to aggregate information relating to both emergency and non-emergency conditions. An example of this aggregation could be the occurrence of an emergency event, the number of outstanding non-emergency events, and variations in arrival times of different events to the emergency event. Thus, the system 600 may use the reporting memory 602 both to aggregate and to add additional information to the transmit queue relating to the plurality of events (e.g., number of events of various kinds, time intervals between emergency events and sensor events, etc.).

As illustrated, in particular embodiments, the reporting memory 602 may bypass the other send queues for transmission directly on the transmission protocol using any of variety of transmission technologies. In other embodiments, the reporting memory 602 may use send queues 110 and/or send queue 502, for example, as shown below.

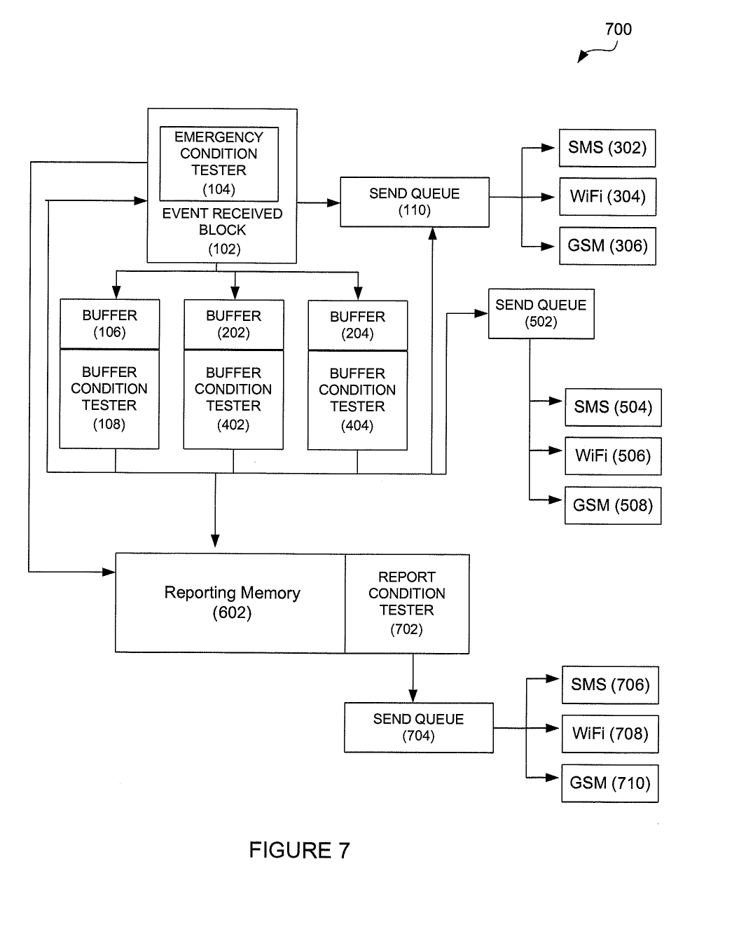

FIG. 7 illustrates a system 700 for concatenating data using a reporting memory and a report condition according to one embodiment of the present disclosure. The system 700 is an example of one implementation of the system 600 in FIG. 6. In this illustrative embodiment, system 700 includes a third send queue 704, a report condition tester 702, and a third occurrence of transport options, SMS transport 706, WiFi transport 708 and GSM transport 710.

In the embodiment illustrated in FIG. 7, the reporting memory 602 may function as an additional buffer that holds data until the report condition tester 702 indicates that the report is ready to be sent. The reporting memory 602 is coupled to the third send queue 704. The system 700 may use the third send queue 704 as a dedicated send queue for information from the reporting memory 602.

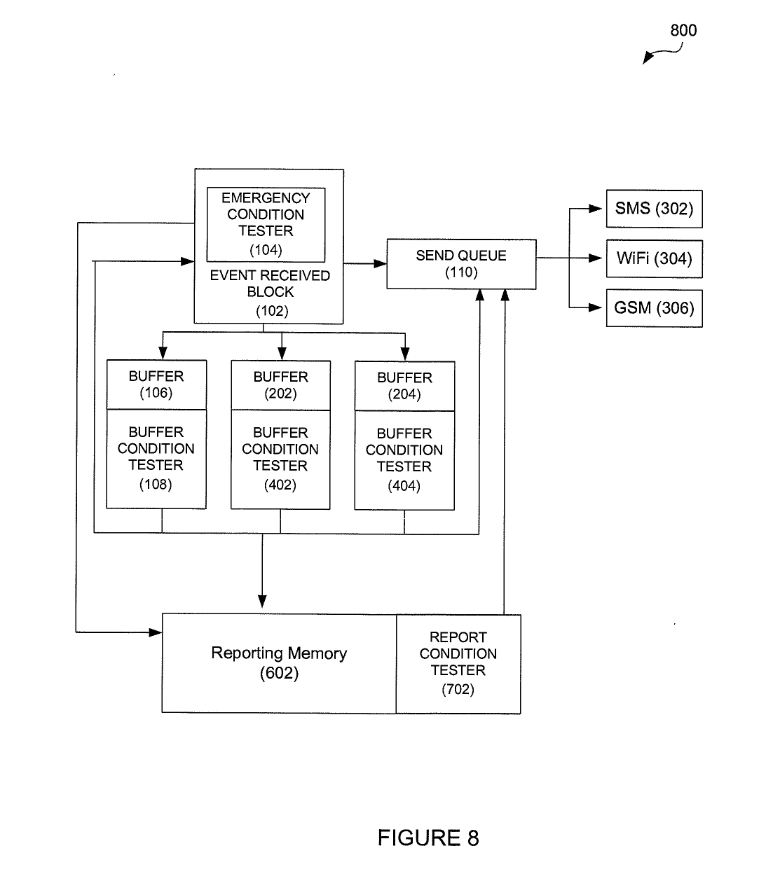

FIG. 8 illustrates a system 800 for concatenating data using a reporting memory and a single sending queue according to one embodiment of the present disclosure. The system 800 is an example of one implementation of the system 700 in FIG. 7 and the system 400 in FIG. 4. In this illustrative embodiment, the system 800 includes a single send queue 110 used for all data, including data from the buffers 106, 202, 204, reporting memory 602, and emergency events. In embodiments where the system 800 is configured to send data in frequent intervals, delay due to a FIFO buffer in the send queue 110 may be reduced. Therefore, the system 800 may use a single buffer for all data. In some embodiments, the system 800 may take emergency events and/or the reporting events out of order, giving priority for emergency event transmission over standard events in the buffer. That is, in such scenarios, standard events may follow a FIFO process whereas emergency events and/or the reporting events may be allowed to “cut in line” for out of order earlier transmission.

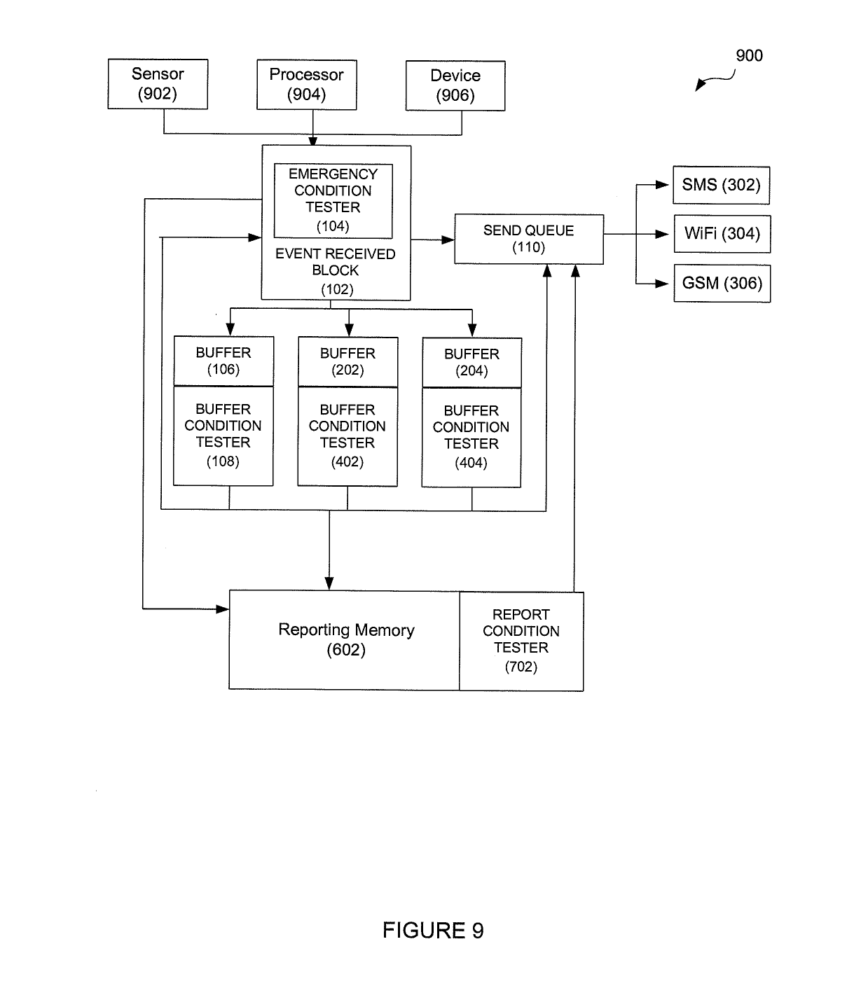

FIG. 9 illustrates a system 900 for concatenating data using a plurality of sensors according to one embodiment of the present disclosure. The system 900 is an example of one implementation of the system 800 in FIG. 8. In this illustrative embodiment, the system 900 includes a plurality of data entry points for the event received block 102 including a sensor 902, a processor 904, and a device 906. The sensor 902, the processor 904, and the device 906 provide information to the event received block 102.

The sensor 902 obtains information including, but not limited to, temperature, location, physical activity or any other information which may be obtained by one or a plurality of sensors. Sensor 902 may be a passive or active sensor that may be powered or unpowered. Sensor 902 may gather any kind of information which may be transmitted to the event received block 102 as an event message.

The processor 904 may provide any kind of information which may be gathered from a mobile device. This processor may create event information to transmit using the system 900. The device 906 is intended to refer to any information which may be passed into the system 900 from any device or system which may be coupled to or external to the system 900.

Although sensor 902, processor 904, and device 906 are shown, any other input mechanism that can provide information for transmission may also be utilized.

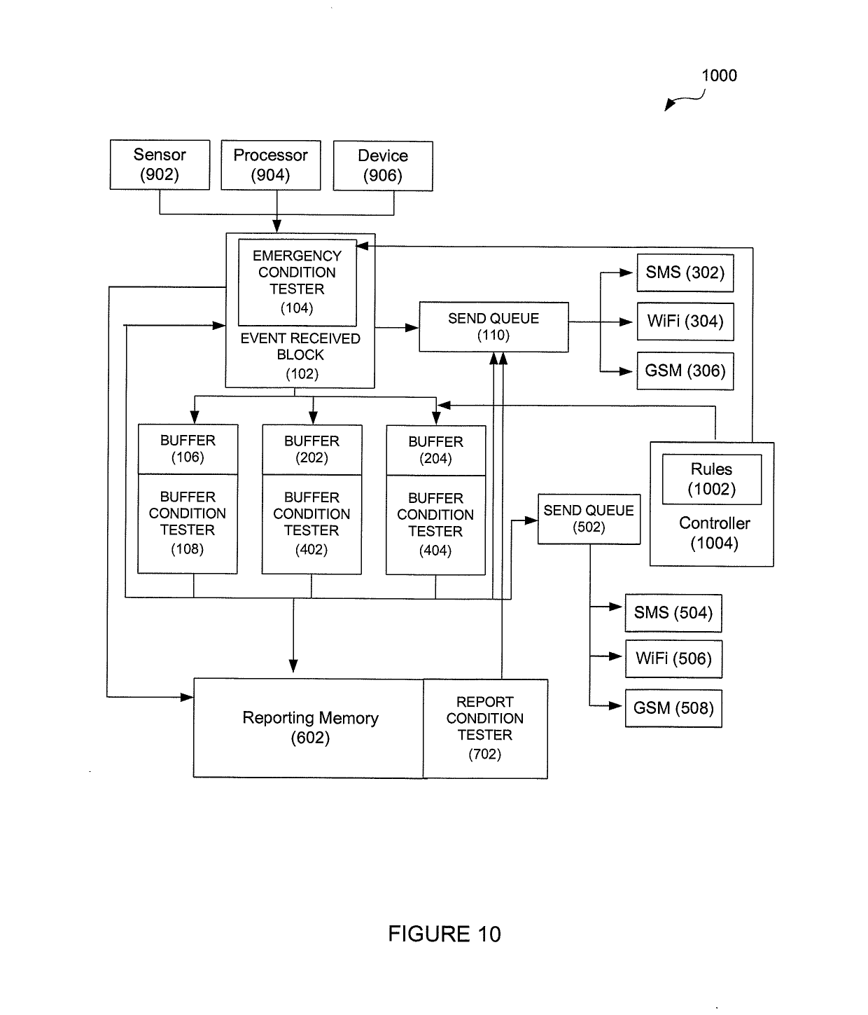

FIG. 10 illustrates a system 1000 for concatenating data using a rules set and a controller according to one embodiment of the present disclosure. The system 1000 is an example of one implementation of the system 900 in FIG. 9. In this illustrative embodiment, the system 1000 includes a controller 1004 and rules 1002. The controller 1004 may be configured to apply rules stored in rules 1002 to the buffers 106, 202, 204 and/or the emergency condition tester 104.

According to certain embodiments, the rules 1002 are based upon changing conditions and/or input by an operator. For example, the rules relating to the buffer condition and/or emergency condition tester 104 may change based upon, among other things, the time of day or the status of a wireless connection. As an example, during peak data cost periods (e.g., the period of the day when the cost to send data is highest), the buffer may be configured to hold data longer than during low cost periods. The buffer may transfer data to a different send queue, based upon availability of transport. It is further understood that there may be a first buffer used for a first transmission technique and a second used for a second transmission technique; e.g., a first send buffer for GSM send data and a second buffer for WiFi data.

As another example, the buffers 106, 202, and 204 may be configured to hold data based upon the status of the wireless connection (e.g., whether the wireless device is in a “roaming” mode or whether the wireless device has connection to a Wi-Fi network) and signal strength. Send queue 110 could be configured to transmit data over a GSM network, and send queue 502 could be configured to transmit data over a Wi-Fi network. In the example of roaming, it may be cost prohibitive to send data unnecessarily over a roaming network. In the example of a Wi-Fi network, it may be more cost efficient to send data over a Wi-Fi network than a GSM network. In the example of signal strength, it may be power prohibitive to transmit data when the signal strength is very weak. In any of these examples, the cost and signal parameters may be programmed into rules 1002 and implemented into buffers 106, 202, and 204 using controller 1004. In these examples, the controller 1004 uses rules 1002 to decide how and when buffers 106, 202 and 204 will be emptied, and the send buffer that would receive the data. It is understood that the examples of device status and signal strength are exemplary only, and not intended to be limiting.

Like the buffer conditions, the emergency condition tester 104 may also be modified based on changing conditions. For example, based on the availability of certain types of networks or the time of day, thresholds can be changed. Additionally, an operator can change which events are designated as emergency events.

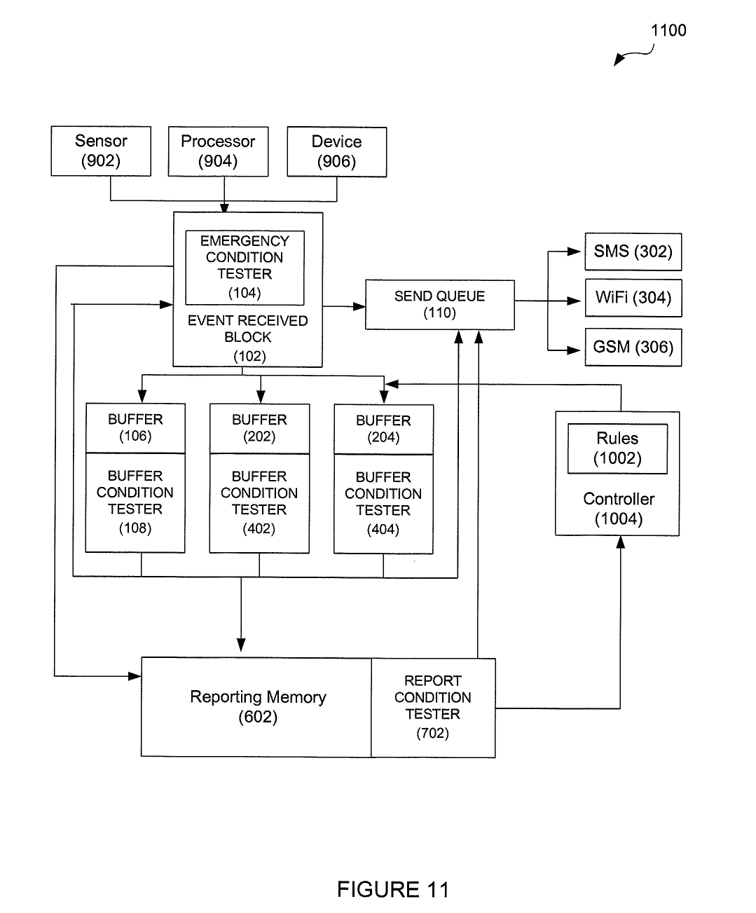

FIG. 11 illustrates a system 1100 for concatenating data using a rule set and a controller according to one embodiment of the present disclosure. The system 1100 is an example of one implementation of the system 1000 in FIG. 10. In this illustrative embodiment, the system 1100 includes the reporting memory 602 coupled to the controller 1004. In this example, the controller has a feedback loop in which to update the implementation of the rules 1002. This feedback loop may be useful, for instance, by the reporting memory 602 reporting the kind of data currently stored in buffers 106, 202, and 204. The controller 1004 may use an awareness of the status of each buffer to customize the data sent by the system 1100.

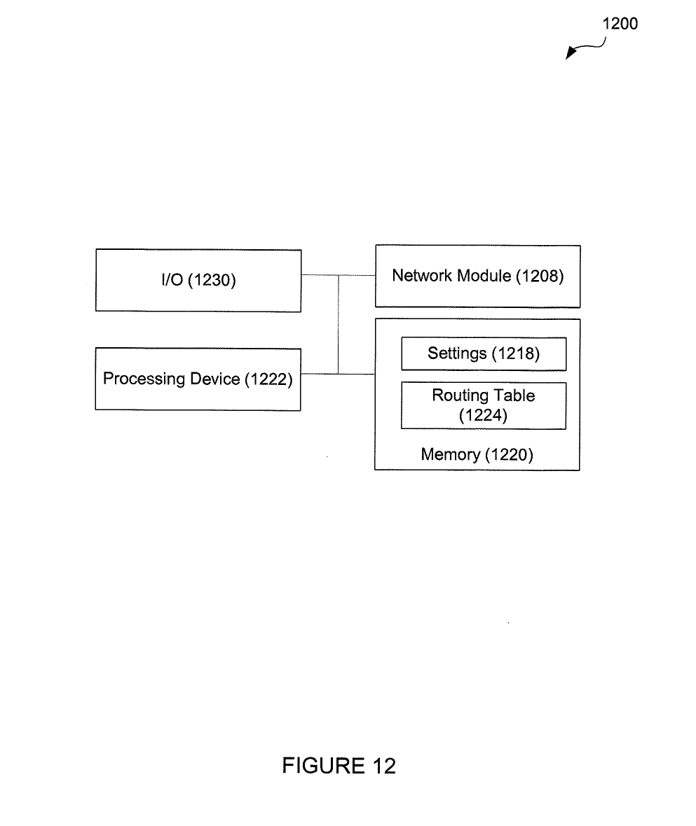

FIG. 12 illustrates an example processing system 1200 which may be used to concatenate messages according to one embodiment of the present disclosure. The processing system 1200 includes at least one memory 1220, at least one processing device 1222, at least one input/output (I/O) 1230, and one network module 1208 that are configured to implement the disclosed systems and methods. In some embodiment, the memory 1220 comprises settings 1218 and routing table 1224. Settings 1218 may be used to store rules 1002. The routing table 1224 may comprise instructions how and when to route specific types of data.

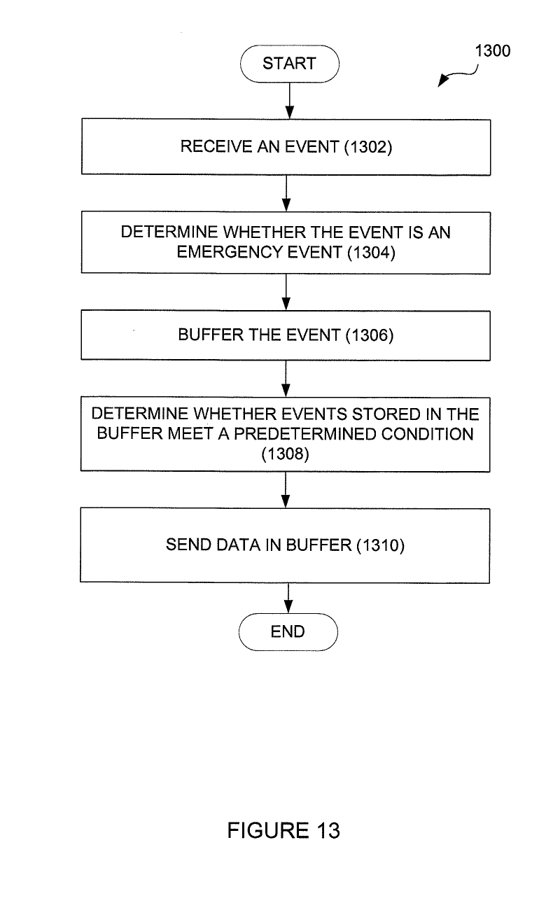

FIG. 13 illustrates a flowchart of a method of sending data according to one embodiment of the present disclosure. For example, the method may be implemented by processing system 1200.

In block 1302, the method receives an event. In block 1304, the method determines whether the event is an emergency event. In block 1306, if the event is not an emergency event, the method stores the event in a buffer. In block 1308, the method determines whether the event stored in the buffer meets a pre-determined condition. In block 1310, if the event meets the pre-determined condition, the method sends the data in the buffer.

Although the figures above illustrate specific systems, structures, and methods, various changes may be made in implementation. For example, various components in the systems and structures can be combined, omitted, further subdivided, or moved according to particular needs. Also, while shown as a series of steps, various steps in FIG. 13 could overlap, occur in parallel, or occur multiple times.

In some embodiments, the logic for carrying out the functions described above may be encoded in software, hardware, or a combination of software or hardware. The software or hardware may supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim:

1. A method comprising:
receiving data associated with an event;
identifying a parameter of the event;
identifying a buffer to store the data associated with the event based on the parameter the event;
storing the data associated with the event in the buffer;
determining whether data stored in the buffer meet a predetermined condition; and
sending the data in the buffer.

2. The method of claim 1, wherein the predetermined condition is based on a priority of the event.

3. The method of claim 1 wherein the predetermined condition is based an amount of time the data has been in the buffer.

4. The method of claim 1, wherein the predetermined condition is based on an amount of the data in the buffer and a cost to transmit the data in the buffer.

5. The method of claim 1, wherein sending the data in the buffer comprises:
responsive to identifying that the parameter of the event indicates the event is a non-emergency event, sending the data associated with event using a first send queue, wherein data associated with an emergency event is sent using a second send queue.

6. The method of claim 1, wherein sending the data in the buffer comprises:
responsive to identifying that the parameter of the event indicates the event is a non-emergency event, sending the data associated with the event and data associated with an emergency event using a send queue while giving the data associated with the emergency event out-of-order priority over the data associated with the non-emergency event in the send queue.

7. The method of claim 1, wherein sending the data in the buffer comprises:
sending the data in the buffer from multiple events using a single data transmission.

8. The method of claim 1, wherein sending the data in the buffer comprises:
sending the sending the data in the buffer using a wireless connection.

9. The method of claim 8 further comprising:
updating the predetermined condition according to a status of the wireless connection.

10. The method of claim 1, wherein the predetermined condition is based upon an availability of transports to transmit the data, wherein the transports include at least one of a GSM network and a WiFi network.

11. The method of claim 10, wherein sending the data in the buffer comprises:
sending the data in the buffer when the WiFi network is available.

12. An apparatus comprising:
a receiver configured to receive data associated with an event;
a controller configured to identify a parameter of the event and identify a buffer to store the data associated with the event based on the parameter the event;
a buffer configured to store the data associated with the event in the buffer;
wherein the controller is further configured to determine whether data stored in the buffer meet a predetermined condition; and
a transmitter configured to send the data in the buffer.

13. The apparatus of claim 12, wherein the predetermined condition is based on a priority of the event

14. The apparatus of claim 12, wherein the predetermined condition is based on an amount of time the data has been in the buffer.

15. The apparatus of claim 12, wherein the predetermined condition is based on an amount of the data in the buffer and a cost to transmit the data in the buffer.

16. The apparatus of claim 12, wherein the transmitter is further configured to send the data associated with event using a first send queue, wherein data associated with an emergency event is sent using a second send queue.

17. The apparatus of claim 12, wherein the controller is further configured to control the transmitter to send the data associated with the event and data associated with an emergency event using a send queue while giving the data associated with the emergency event out-of-order priority over the data associated with the non-emergency event in the send queue.

18. The apparatus of claim 12, wherein the transmitter is further configured to send the data in the buffer from multiple events using a single data transmission.

19. The apparatus of claim 11, wherein the transmitter is further configured to send the sending the data in the buffer using a wireless connection.

20. A non-transitory computer readable medium embodying instructions that, when executed, cause one or more processing systems to:
receive data associated with an event;
identify a parameter of the event;
identify a buffer to store the data associated with the event based on the parameter the event;
store the data associated with the event in the buffer;
determine whether data stored in the buffer meet a predetermined condition; and
send the data in the buffer.

21. The computer readable medium of claim 20, wherein the predetermined condition is based on an amount of the data in the buffer and a cost to transmit the data in the buffer.

22. The computer readable medium of claim 20, wherein the instructions that cause one or more processing systems to send the data in the buffer include instructions that cause one or more processing systems to send the data in the buffer from multiple events using a single data transmission.
